(19) United States
(12) Patent Application Publication
(10) Pub. No.: US 2007/0213886 A1
(43) Pub. Date: Sep. 13, 2007

(54) Method and system for driver handling skill recognition through driver's steering behavior

(76) Inventors: Yilu Zhang, Plymouth, MI (US); William C. Lin, Troy, MI (US); Yuen-Kwok Chin, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/372,807

(22) Filed: Mar. 10, 2006

(51) Int. Cl. G05D 1/00

(52) U.S. Cl. 701/1

(57) ABSTRACT

A driver handling skill recognition system and related algorithm that identifies a driver skill level. The system includes a steering wheel angle processor responsive to a steering wheel angle signal that provides normalized DFT coefficients. The system also includes at least one feed-forward artificial neural network (FF-ANN) responsive to the normalized DFT coefficients, where the FF-ANN provides an output signal indicative of the driver skill level. In one embodiment, the system includes a plurality of FF-ANNs one for each of a plurality of different vehicle maneuvers. The system includes a maneuver identifier that identifies a vehicle maneuver. The system selects the output from one of the FF-ANNs depending on the identified maneuver. In an alternate embodiment, the system can include a single FF-ANN designed for a plurality of vehicle maneuvers.

### BACKGROUND OF THE INVENTION

1. Field of the Invention

This invention relates generally to a system and method for identifying a driver's skill level and, more particularly, to a system and method for identifying a driver's skill level that includes identifying a driving maneuver and then using an output from a feed-forward artificial neural network for that maneuver to provide the driver's skill level.

2. Discussion of the Related Art

Vehicle driving is a process that includes driver/vehicle interactions. Safe and pleasant driving experiences depend not only on the ride and handling performance of the vehicle, but also on the driver's capability to operate and control the vehicle properly. Many tasks relate to driver/vehicle interaction from the most direct control of the vehicle's motion to the planning of vehicle guidance and navigation, as well as other auxiliary vehicle controls, such as communication and operation of various other vehicle devices. All of these tasks require various degrees of driver attention and mental capacity, as well as physical responsiveness to execute.

In general, all of the tasks referred to above are related to the driver's ability to handle and control the vehicle. Given the same vehicle and the same driving situation, the vehicle maneuvers and vehicle performance can differ due to various factors affecting the driver's capability of controlling the vehicle, including the driver's intrinsic ability and the amount of burden imposed by secondary tasks. For example, a response of the vehicle may give a driver the chance to quickly maneuver in emergency situations. However, certain conditions, such as the high steering gain, may not be well handled by a young or inexperienced driver. On the other hand, given the same vehicle and driver, the ability to handle a difficult maneuver may differ when the driver is fully concentrating on driving or is occupied by the vehicle's information and/or entertainment systems.

Apparently, driving skills as judged from handling the vehicle maneuvering is not a simple issue to address, although the benefit of 4 having such information for vehicle control is recognized. For example, with the knowledge of driving skill, various safety and/or pleasure related services can be provided to the driver accordingly. Furthermore, when the driver is not skillful, the chassis controls can be retuned, the seatbelt can be tightened and other information to the driver can be provided.

There have been significant activities in the field of driver response modeling in the past few decades. The primary goal of most of these activities is to generate vehicle control signals or commands so that the vehicle is driven automatically. Very few research activities have been reported in exclusively characterizing and identifying driver skill level.

One known concept car, referred to as the Pod, explores the potential for communications between people and their vehicle. It has been reported that a Pod can detect its user's driving skills and compare them to prerecorded driving data of an expert driver. It then displays words of praise or warning on a monitor. In another design, an abnormal-driver warning system warns drivers when they are veering from normal driving. The system detects the abnormality by matching information it takes in against a database of average driving performance.

### SUMMARY OF THE INVENTION

In accordance with the teachings of the present invention, a driver handling skill recognition system and related algorithm is disclosed that identifies a driver skill level. The system includes a steering wheel angle processor responsive to a steering wheel angle signal that generates normalized DFT coefficients. The system also includes at least one feed-forward artificial neural network (FF-ANN) responsive to the normalized DFT coefficients, where the FF-ANN provides an output signal indicative of the driver skill level. In one embodiment, the system includes a plurality of FF-ANNs one for each of a plurality of different vehicle maneuvers. The system includes a maneuver identifier that identifies a vehicle maneuver. The system selects the output from one of the FF-ANNs depending on the identified maneuver. In an alternate embodiment, the system can include a single FF-ANN designed for a plurality of vehicle maneuvers of interest.

Additional features of the present invention will become apparent from the following description and appended claims taken in conjunction with the accompanying drawings.

### BRIEF DESCRIPTION OF THE DRAWING

FIG. 1 is a graph with frequency on the horizontal axis and magnitude on the vertical axis showing an FFT of a steering wheel angle for an expert driver at different speeds;

FIG. 2 is a graph with frequency on the horizontal axis and magnitude on the vertical axis showing an FFT of a steering wheel angle for a novice driver at different speeds;

FIG. 3 is a block diagram of a system for providing steering-behavior based driver handling skill recognition, according to an embodiment of the present invention;

FIG. 4 is a flow chart diagram showing an off-line design process for a FF-ANN recognizer, according to an embodiment of the present invention;

FIG. 5 is a flow chart diagram showing a process for computing normalized DFT coefficients, according to an embodiment of the present invention;

FIG. 6 is a flow chart diagram showing a process for maneuver identification, according to an embodiment of the present invention;

FIG. 7 is a flow chart diagram showing a process for the recognition of a multiple FF-ANN recognizer; and

FIG. 8 is a block diagram of a single FF-ANN, according to embodiment of the present invention.

### DETAILED DESCRIPTION OF THE EMBODIMENTS

The following discussion of the embodiments of the invention directed to a system and related algorithm for identifying a driver skill level is merely exemplary in nature, and is in no way intended to limit the invention or its applications or uses.

As will be discussed below, the present invention provides a system and related method that recognizes a driver handling skill level. In order to recognize the driver skill level, it is essential to find discriminate features that can best differentiate drivers with different handling skill levels. According to the invention, discrete Fourier transform (DFT) coefficients of the steering wheel angle have been shown to provide such discriminate features.

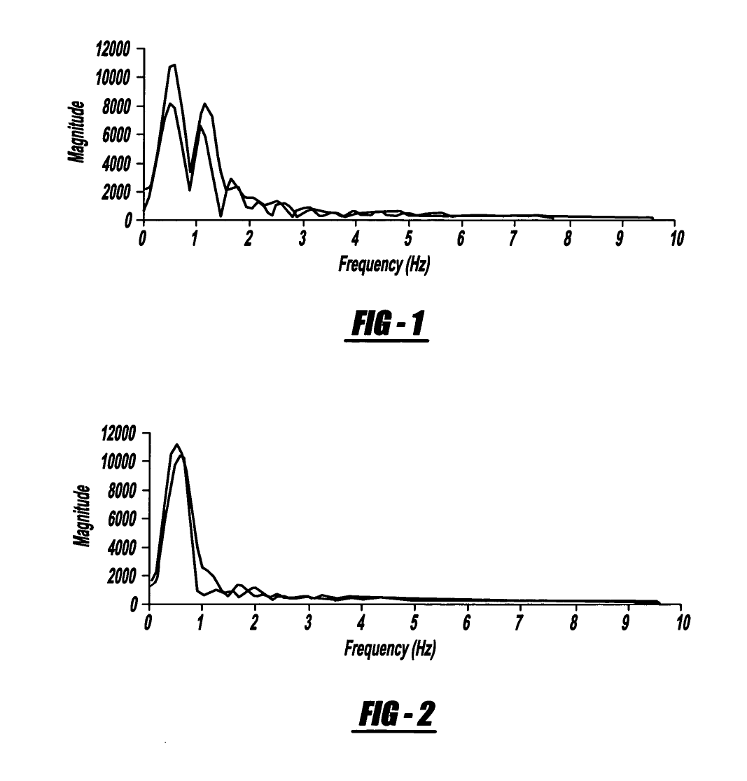

As is well understood to those skilled in the art, Fourier analysis decomposes a waveform signal in terms of sinuosoidal components and provides a representation of the signal in the frequency domain. FIG. 1 shows the magnitude of DFT coefficients from driver steering wheel readings for a high-skill driver during two double-lane change (DLC) maneuvers at different speeds. The magnitude of the DFT coefficients can be interpreted as the power or the energy of the components with different frequencies in the waveform. The two peaks around 0.5 Hz and 1.1 Hz imply that this driver's steering behavior has two major frequency components, a slow one at about 0.5 Hz and a fast one at about 1.1 Hz.

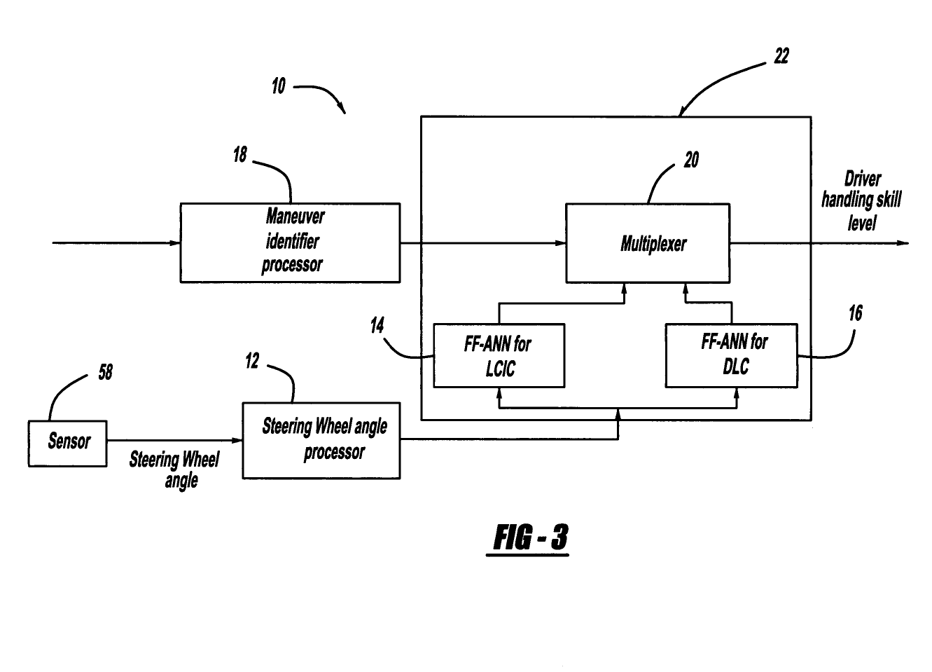

FIG. 2 shows the magnitude of DFT coefficients from driver steering wheel readings for a low-skilled driver during two DLC maneuvers at different speeds. Compared to the expert driver, the low-skill driver does not produce the high-frequency peak. This difference between high-skill and low-skill drivers can be used to differentiate drivers with different skill levels.

Maneuvers at different speeds require different steering responses from a driver without regard to the driver's skill level. Usually, the faster a person drives, the faster they steer the vehicle in order to finish a maneuver, such as making a turn. As a result, the DFT coefficients of the steering wheel angle scale along the frequency axis with respect to the vehicle speed. The scaling factor distorts the consistence of the discriminate features within each driver group and will affect the recognition performance. To reduce this complication, a scaling normalization can be performed as:

$$g ( f ) = {g}_{v} ( f \frac{{v}_{0}}{v} ) \qquad ( 1 )$$

Where g is the normalized DFT coefficients, f is the frequency, gᵥ is the original DFT coefficients of the maneuver at speed v, and v₀ is the normalized speed.

FIG. 3 is a block diagram of a driver handling skill recognition system 10, according to an embodiment of the present invention. The system 10 includes a steering wheel angle processor 12 that receives a steering wheel angle signal, generally from a sensor 58 on the steering wheel of the vehicle. The processor 12 computes the discriminate features and the normalized DFT coefficients of the steering wheel angle. The steering wheel angle can also be received from the vehicle serial data link. In order to capture the dynamics of the driving steering behavior, the steering wheel angle is sampled at a frequency of, for example, 50 Hz. To generate the DFT coefficients, a size for the time window of the DFT coefficient must be identified. Although the optimal size may be determined by further investigation, a rule of thumb is to make it long enough to cover a usual maneuver, such as cornering and lane changing, which is typically within ten seconds. Considering the sampling rate of 50 Hz, a 512 DFT coefficient should be adequate.

According to the invention, a neural network is provided for each different maneuver that gives a driver handling skill level based on normalized DFT coefficients off-line. These neural networks are then implemented in the vehicle so that the system 10 can identify the driver skill level during driving. In the system 10 there are two neural networks for two different vehicle maneuvers. Particularly, the system 10 includes a driver handling skill level recognizer 22 having a feed-forward artificial neural network (FF-ANN) 14 for a lane-change in a curve (LCIC) maneuver and an FF-ANN 16 for a double lane change (DLC) maneuver. The normalized DFT coefficients from the processor 12 are provided to both the FF-ANN 14 and the FF-ANN 16, so that an output of both of the FF-ANNs 14 and 16 provide a driver handling skill level for that particular maneuver. The LCIC and the DLC maneuvers are merely representative examples in that any suitable number of FF-ANNs can be provided in the system 10 for any desirable maneuver.

The system 10 also includes a maneuver identifier processor 18 that receives various inputs, such as a digital map, GPS information, yaw rate, lateral acceleration, longitudinal acceleration, brake pedal position, etc. The maneuver identifier processor 18 can use any suitable algorithm for identifying the maneuver as would be well understood to those skilled in the art. The processor 18 identifies the maneuver that the driver is conducting at each moment during the driving and provides a maneuver index value identifying the particular maneuver. The maneuver index value is received by a multiplexer 20 that selects the output from the FF-ANN 14 or the FF-ANN 16 if the maneuver identifier processor 18 identifies an LCIC or a DLC. The output of the multiplexer 20 is the output value from the FF-ANN 14 or the FF-ANN 16 depending on the maneuver. In one embodiment, the outputs of the FF-ANN 14 and the FF-ANN 16 are a value of 0, 1 or 2, where 0 is for a novice driver, 1 is for an average driver and 2 is for an expert driver. However, these values are by way of a non-limiting embodiment in that more values can be provided for higher resolution.

The driver skill level value can be used in any suitable vehicle system to increase vehicle control, such as a vehicle stability enhancement system, differential braking system, active steering system, etc.

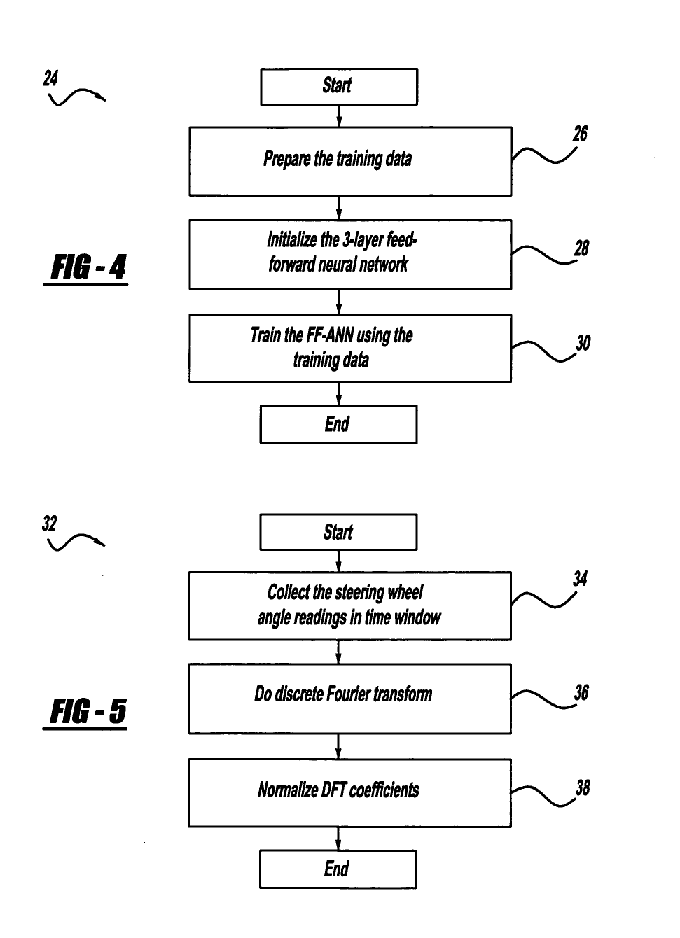

FIG. 4 is a flow chart diagram 24 showing a process for training the FF-ANNs 14 and 16 off-line to identify the driver handling skill level for the particular maneuver. The process prepares a training data set at box 26 that may include the magnitude of the DFT coefficients of the steering wheel angle readings for different drivers under a particular maneuver. The labels of the data contributed by expert drivers and novice drivers are 1 and 0, respectively. The process then initializes a three-layer FF-ANN at box 28. The dimension of the inputs to the network is 30 because the first 30 coefficients of the DFT are used in this non-limiting embodiment. The number of neurons in the hidden and output layers can be 60 and 1, respectively. The weights can be initialized as random numbers between 0 and 1. The transfer function in the hidden layer is a logarithmic sigmoid, and the transfer function in the output function is a step function. The process then trains the FF-ANN using the training data at box 30. In one non-limiting embodiment, the Levenberg-Marquardt algorithm is used for training the weights of the FF-ANN, however, other algorithms can be used as would be appreciated by those skilled in the art.

FIG. 5 is a flow chart diagram 30 showing a process for performing the steering wheel angle signal processing in the processor 12. The algorithm collects the steering wheel angle readings during a predetermined time window at box 32. The algorithm then performs a discrete Fourier transform on the steering wheel angle signals to convert them to the frequency domain and generate DFT coefficients at box 34. The processor 12 then normalizes the DFT coefficients with respect to speed, using, for example, equation (1) at box 36.

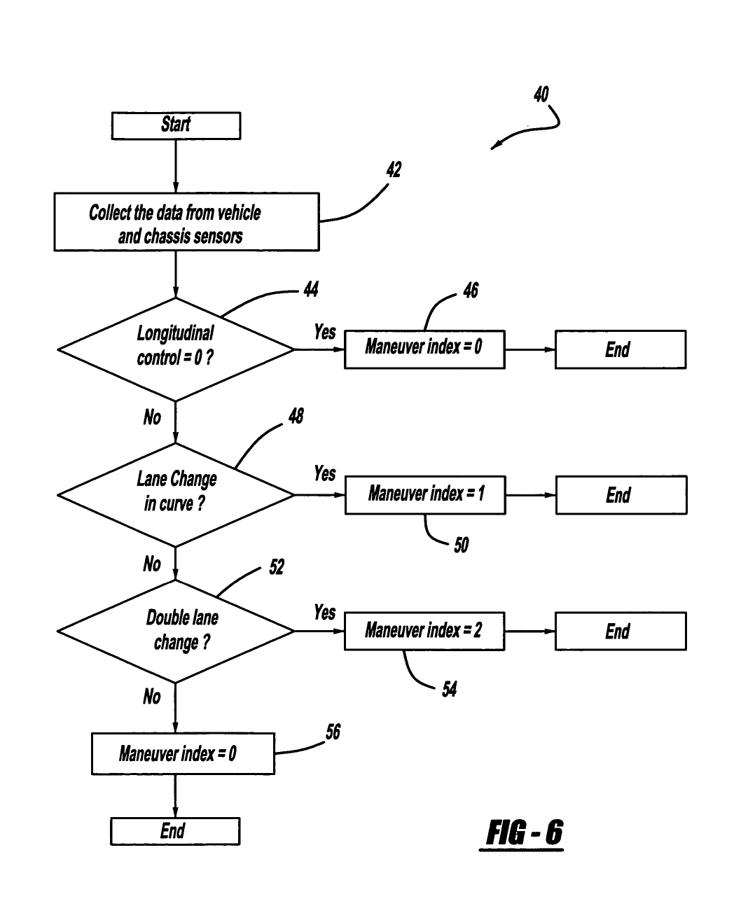

FIG. 6 is a flow chart diagram 40 showing a process for determining the maneuver index at the output of the maneuver identifier processor 18. The maneuver identifier algorithm collects the data from the vehicle and chassis sensors, such as a digital map, GPS information, yaw rate, lateral acceleration, longitudinal acceleration, brake pedal switch, etc. at box 42. The algorithm then determines whether the vehicle is traveling in a straight line at decision diamond 44 by determining whether the longitudinal control of the vehicle is equal to 0. If the vehicle is traveling in a straight line, then the algorithm sets the maneuver index value to 0 at box 46. When the maneuver index is 0, then the output of the multiplexer 20 does not provide a driver handling skill level in this embodiment. If the longitudinal control indicates that the vehicle is not traveling in a straight line at the decision diamond 44, then the algorithm determines whether the vehicle is performing a lane change in curve maneuver at decision diamond 48. If the algorithm determines that the vehicle is performing a lane change in curve maneuver at the decision diamond 48, then it will output a maneuver index of 1 at box 50, which causes the multiplexer 20 to output the skill level value from the FF-ANN 14. If the algorithm determines that the vehicle is not performing a lane change in curve maneuver at the decision diamond 48, the algorithm will then determine whether the vehicle is performing a double lane change maneuver at decision diamond 52. If the algorithm determines that the vehicle is performing a double lane change maneuver at the decision diamond 32, it will output a maneuver index of 2 at box 54, which will cause the multiplexer 20 to output the skill level value from the FF-ANN 16. If the algorithm determines that the vehicle is not performing a double lane change maneuver at the decision diamond 52, then it will output a maneuver index of 0 at box 56, which indicates that the vehicle is performing a maneuver other than a lane change in curve or a double lane change. As above, the maneuver index of 0 does not provide an output of the multiplexer 20.

The function of the driver handling skill level recognizer 22 is to discriminate drivers with different skill levels based on the discriminate features. The discussion above uses the FF-ANN to illustrate how to design and use a recognizer for this purpose. However, any pattern recognition technique can be used to accomplish the same goal, such as a decision tree, decision rules, neural networks, vector quantization, support vector machines, Bayesian networks, hidden Markov models, etc.

FIG. 7 is a flow chart diagram 60 showing a process for operating the driver handling skill level recognizer 22. The normalized DFT coefficients of the steering wheel angle are sent to the FF-ANNs 14 and 16 from the processor 12 at box 62. The recognizer 22 then determines whether the maneuver index is 0 at the decision diamond 64. If the maneuver index is 0 at the decision diamond 64, then the recognizer 22 does not recognize the maneuver at box 66. If the maneuver index is 1 or 2 at the decision diamond 64, then the multiplexer 20 selects the output from the FF-ANN 14 or 16 corresponding to the maneuver provided by the maneuver identifier 18 at box 68. The recognizer 22 then determines whether the output of the FF-ANN 14 or 16 is 1 at decision diamond 70, and if so, indicates that the driver handling skill level is for an expert driver at box 72. If the output of the FF-ANN 14 or 16 is not 1, then the recognizer outputs a signal for a novice driver at box 74.

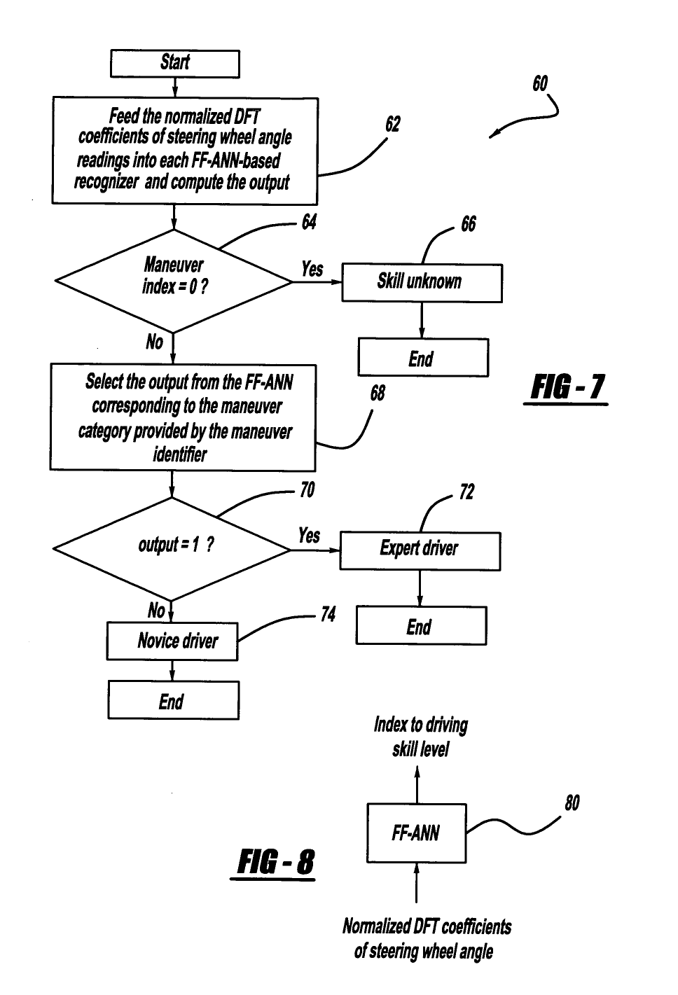

In an alternate embodiment, all of the FF-ANNs can be combined into a single FF-ANN for all identified maneuvers. FIG. 8 shows an FF-ANN 80 used for this purpose. In this embodiment, the maneuver identifier processor 18 is not needed because the particular maneuver is not identified. Further, the multiplexer 20 is not needed because there is only one FF-ANN. Therefore, based on the signal processing of the steering wheel angle and the processor 12 providing the normalized DFT coefficients, a particular index for the driving skill level is output from the FF-ANN 80 irregardless of the particular maneuver. The FF-ANN 80 might not be as accurate as an FF-ANN designed for a particular maneuver, but it may be satisfactory enough, and provide a cost reduction. The FF-ANN 80 would have to be trained using data from all different maneuvers of interest.

Further, in an alternate embodiment, it may be desirable to accumulate the driver handling skill level index for a particular maneuver for a predetermined number of the maneuvers to get a more accurate reading. For example, if the output of the FF-ANNs 14 or 16 is sampled over 10 of the particular maneuvers, an average can be taken to more accurately identify the driver handling skill level.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A driver skill recognition system for identifying a driver skill level, said system comprising:
a steering wheel angle processor responsive to a steering wheel angle signal and providing normalized discreet Fourier Transform (DFT) coefficients; and
at least one feed-forward artificial neural network (FF-ANN) responsive to the normalized DFT coefficients, said at least one FF-ANN providing an output signal indicative of the driver skill level.

2. The system according to claim 1 wherein the at least one FF-ANN is at least two FF-ANNs, wherein a first FF-ANN provides a driver skill level signal for a first predetermined vehicle maneuver and a second FF-ANN provides a driver skill level signal for a second predetermined vehicle maneuver.

3. The system according to claim 2 further comprising a maneuver identifier, said maneuver identifier identifying a vehicle maneuver, wherein the system selects the output from the first or second FF-ANN depending on the identified maneuver.

4. The system according to claim 3 wherein the maneuver identifier receives information from the group consisting of a digital map, GPS receiver, vehicle yaw rate, vehicle lateral acceleration, vehicle longitudinal acceleration and brake pedal switch.

5. The system according to claim 2 wherein the first FF-ANN is for a lane-change in curve maneuver and the second FF-ANN is for a double lane change maneuver.

6. The system according to claim 1 wherein the at least one FF-ANN is a single FF-ANN designed for a plurality of vehicle maneuvers.

7. The system according to claim 1 wherein the driver skill level is for an expert driver or a novice driver.

8. The system according to claim 1 wherein the at least one FF-ANN is trained off-line.

9. The system according to claim 1 wherein the steering wheel angle processor samples the steering wheel angle at a frequency of about 50 Hz.

10. The system according to claim 1 wherein the system samples the driver skill level output signal from the at least one FF-ANN over a predetermined sample period, and averages the sample driver skill level output signals to provide a more accurate driver handling skill level.

11. A driver skill recognition system for identifying a driver skill level, said system comprising:
a steering wheel angle processor responsive to a vehicle condition signal and providing a representation signal of the vehicle condition signal; and
at least one feed-forward artificial neural network (FF-ANN) responsive to the representation signal, said at least one FF-ANN providing an output signal indicative of the driver skill level.

12. The system according to claim 11 wherein the vehicle condition signal is a vehicle steering angle signal.

13. The system according to claim 11 wherein the representation signal is normalized discreet Fourier Transform (DFT) coefficients.

14. The system according to claim 11 wherein the at least one FF-ANN is at least two FF-ANNs, wherein a first FF-ANN provides a driver skill level for a first predetermined vehicle maneuver and a second FF-ANN provides a driver skill level signal for a second predetermined vehicle maneuver.

15. The system according to claim 14 further comprising a maneuver identifier, said maneuver identifier identifying a vehicle maneuver, wherein the system selects the output from the first or second FF-ANN depending on the identified maneuver.

16. The system according to claim 11 wherein the at least one FF-ANN is a single FF-ANN designed for a plurality of vehicle maneuvers.

17. The system according to claim 11 wherein the system samples the driver skill level output signal from the at least one FF-ANN over a predetermined sample period, and averages the sample driver skill level output signals to provide a more accurate driver handling skill level.

18. A driver skill recognition system for identifying a driver skill level, said system comprising:
a steering wheel angle processor responsive to a steering wheel angle signal and providing normalized discreet Fourier Transform (DFT) coefficients;
at least two feed-forward artificial neural networks (FF-ANNs) responsive to the normalized DFT coefficients, said at least two FF-ANNs separately providing output values indicative of the driver skill level for two different vehicle maneuvers;
a maneuver identifier identifying a vehicle maneuver and providing a maneuver signal identifying the maneuver; and
a multiplexer responsive to the output values from the FF-ANNs and the maneuver signal, said multiplexer outputting the value from one of the FF-ANNs depending on the identified maneuver.

19. The system according to claim 18 wherein the maneuver identifier receives information from the group consisting of a digital map, GPS receiver, vehicle yaw rate, vehicle lateral acceleration, vehicle longitudinal acceleration and brake pedal switch.

20. The system according to claim 18 wherein the FF-ANNs are trained off-line.

21. The system according to claim 18 wherein a first FF-ANN is for a lane-change in curve maneuver and a second FF-ANN is for a double lane change maneuver.
